(19) United States
(12) Patent Application Publication
(10) Pub. No.: US 2026/0187684 A1
(43) Pub. Date: Jul. 2, 2026

(54) DEVICE FOR AUTOMATED COLLECTIBLE OBJECT GRADING, LABELING, AND ENCAPSULATING

(71) Applicant: AGS, Inc., Staten Island, NY (US)

(72) Inventors: Alex Aleksandrovski, Jersey City, NJ (US); Eric Sinko, Norwalk, CT (US)

(21) Appl. No.: 19/382,220

(22) Filed: Nov. 6, 2025

Related U.S. Application Data
(63) Continuation-in-part of application No. 18/107,293, filed on Feb. 8, 2023.
(60) Provisional application No. 63/308,036, filed on Feb. 8, 2022.

(51) Int. Cl. G06Q 30/02; G06Q 30/018; H04N 23/50

(52) U.S. Cl. CPC G06Q 30/0278; G06Q 30/0185; H04N 23/50

(57) ABSTRACT

The present invention is a computerized system for grading an object, comprising: an enclosure; a platform designed to receive an object; a track system integrated into the enclosure and wherein the platform is attached to the track system; a scanning system integrated into the enclosure relative to the track system, wherein the scanning system is configured to capture at least one image of the object; and a computer system connected to the scanning system and the track system, comprising at least one processor.

### CROSS-REFERENCE TO RELATED APPLICATIONS

This application is a continuation-in-part (and claims the benefit of priority under 35 USC 120) of U.S. provisional application No. 63/308,036 filed February 8^{th}, 2022 and continuation-in-part (and claims the benefit of priority under 35 USC 120) of U.S. utility application Ser. No. 18/107,293 filed on February 8^{th}, 2023. The disclosure of the prior applications is considered part of (and is incorporated by reference in) the disclosure of this application.

### BACKGROUND

This disclosure relates generally a device to authentic collectibles, and more specifically to a method and system that would grade collectable items to determine the authenticity of said item.

Trading cards, trading card games, and collectible cards have been a staple of the collectible community for over 100 years, having grown into a $370 B industry. Trading cards capture a moment in time, often representing a moment in time, a sport, game, fictional, or non-fictional genre. These collectibles hold immense vintage, nostalgic, and antique value and often can be worth in the millions for a single card.

Collective value assignment and authenticity of collectibles is a major concern for market participants. Fraudsters often attempt to make fake cards or conceal the damage of a card. Damages and defects indicate the value of a card based on a numeric “grade” and subsequent subgrades, which represent categories of quality (e.g., centering, edges, corners, surface). Many companies exist in the market which perform “grading” of cards in which the company as a third party reviews the card confirming authenticity, assessing damages, slabbing or encapsulating the card in a plastic slab, and assigning a grade to the card. Some groups in previous art (included) have sought computerized methods of performing the “grade”. Using a camera alone is not a novel approach to scanning a card, as the same method is used throughout a multitude of defect detection applications.

Grading is a complex manual process. There are many complications in automating the grading process, particularly in physically handling the card (including flipping the card), deciding which data to acquire from the card, deciding the methods to acquire that data, processing that data using methods that scale, providing error handling and continuity conditions for bulk grading, and much more.

Grading cards is based on various characteristics that pertain to the “general eye appeal” of the card. Characteristics of the card that are universally examined in the grading process are centering, corners, edges, and surface. Centering is the placement of the image (top to bottom and left to right) on the card relative to the card borders. Industry standards exist for percentage of off-centering variance permitted for each of the possible card grades. The corners of the card are inspected to determine the quality of the physical condition of the corner and/or if any defect of the corners is present. The edges of the card are examined, similarly to the corners, to determine the quality of the physical condition of the edges of the card, and account for any damage and/or imperfections along the edges. The surface of the card is examined to account for any damage and/or imperfections on the card, such as scratches, creases, tears, pinholes, stains, dents, attempts at recoloring, etc.

Grading is, with extremely rare exception, the most significant determination of value, such fluctuations in grading often result in misstatement of value and lack of confidence in the marketplace necessary to sustain a stable and efficient market.

Therefore, it is desired for an autonomous solution that would handle the entire grading process.

### SUMMARY

In a first embodiment, the present invention is a computerized system for grading an object, comprising: an enclosure; a platform designed to receive an object; a track system integrated into the enclosure and wherein the platform is attached to the track system; a scanning system integrated into the enclosure relative to the track system, wherein the scanning system is configured to capture at least one image of the object; and a computer system connected to the scanning system and the track system, comprising at least one processor.

In a second embodiment, the present invention is a computerized system for grading an object, comprising: an enclosure; a rotatable platform designed to receive an object; a track system integrated into the enclosure and wherein the platform is attached to the track system; a vision system integrated into the enclosure relative to the track system; a scanning system integrated into the enclosure relative to the track system and the vision system, wherein the scanning system is configured to capture at least one image of the object; and a computer system connected to the scanning system and the track system, comprising at least one processor.

In a second embodiment, the present invention is a computerized system for grading an object, comprising: an enclosure; a platform designed to receive an object; a track system integrated into the enclosure and wherein the platform is attached to the track system; a vision system integrated into the enclosure relative to the track system; a scanning system integrated into the enclosure relative to the track system, wherein the scanning system is configured to capture at least one image of the object; a computer system connected to the scanning system and the track system, comprising at least one processor; and at least one interactive screen integrated into the enclosure electrically connected to the computer system.

### BRIEF DESCRIPTION OF THE DRAWINGS

FIG. 1 depicts an isometric view of a grading machine, according to an embodiment of the present invention.

FIG. 2 depicts a side view of the grading machine, according to an embodiment of the present invention.

FIG. 3 depicts a side view of the grading machine, according to an embodiment of the present invention.

FIG. 4 depicts a top view of the grading machine, according to an embodiment of the present invention.

FIG. 5 depicts a front view of the grading machine, according to an embodiment of the present invention.

FIG. 6 depicts a back view of the grading machine, according to an embodiment of the present invention.

FIG. 7 depicts an exploded view of the grading machine, according to an embodiment of the present invention.

FIG. 8 depicts a section view of the grading machine, according to an embodiment of the present invention.

FIG. 9 depicts a section view of the grading machine, according to an embodiment of the present invention.

FIG. 10 depicts a section view of the grading machine, according to an embodiment of the present invention.

FIG. 11 depicts a side section view of the grading machine, according to an embodiment of the present invention.

FIG. 12 depicts a side section view of the grading machine, according to an embodiment of the present invention.

FIG. 13 depicts a top section view of the grading machine, according to an embodiment of the present invention.

FIG. 14 depicts a front section view of the grading machine, according to an embodiment of the present invention.

FIG. 15 depicts a rear section view of the grading machine, according to an embodiment of the present invention.

FIG. 16 depicts a block diagram depicting a computing environment, according to another embodiment of the present invention.

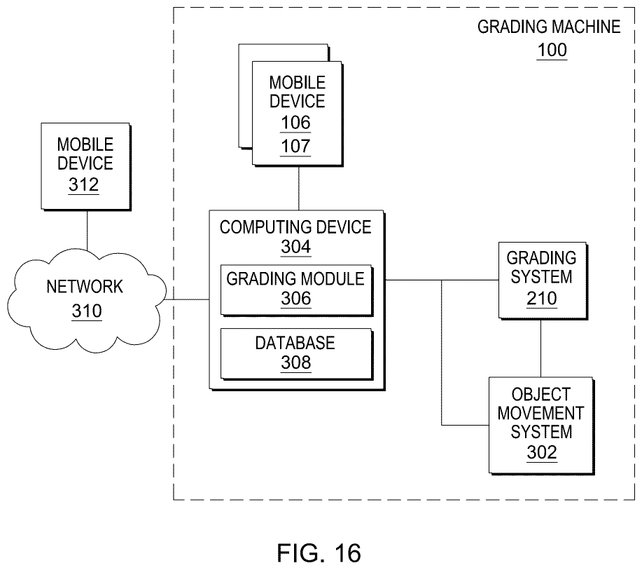

FIG. 17 depicts a block diagram of a computing device, according to an embodiment of the present invention.

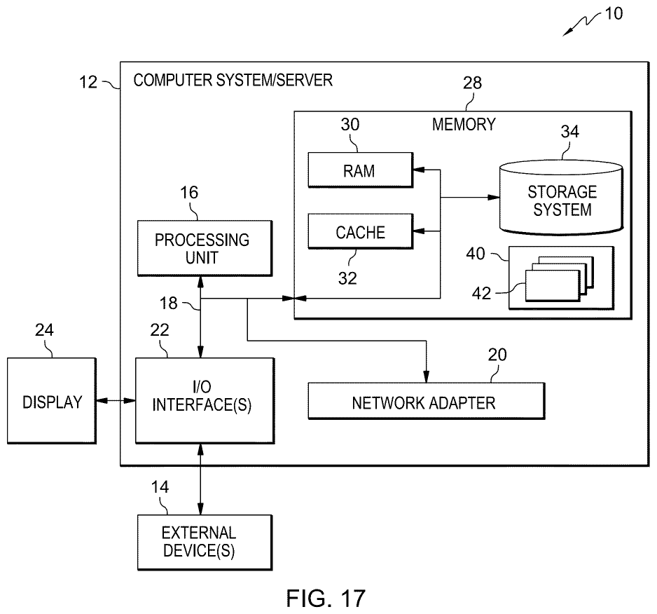

### DETAILED DESCRIPTION

The present invention relates to an automated machine system that automatically scans, grades, and slabs collectibles and the methods associated. The system is a combination of hardware and software components including but not limited to lasers, cameras, chemical sensors, microscopy, light spectroscopy, machine learning techniques, artificial intelligence, computer vision, advanced robotics assemblies and actuators, and surrounding computing and mechanical infrastructure. The primary embodiment relates to trading cards, although the system and processes are applicable to all collectibles including coins, large 3D objects, stamps, comics, and more.

Trading cards and collectible enthusiasts desire the cards or collectibles to be in the finest condition. Collectors do not want to overpay for a low-quality card or sell a high-quality card for less than it is worth. The industry is at least a 13 billion dollars, and some of these cards can be valued well over tens of thousands of dollars. The condition of these cards is the main driver of their value. Improper grading of the condition of these collectibles by professional graders can result in thousands of dollars of undervalued or overvalued cards.

Currently, commercial and private grading companies use professional graders to manually grade many cards. Experienced graders can spot the smallest of imperfections that can affect the value of a cards by hundreds or thousands of dollars. Experience is therefore the most important quality of a professional grader; however, the professional grader is subjective. What the industry is lacking is the experience of a professional grader with an objective view of card grading. This is the advantage of the present invention.

Grading of a card is currently performed by machines and/or the human eye and there is much subjectivity involved in grading. If the same card is graded twice by a grading company, it is highly likely that the grades obtained for the same card during two different grading sessions are different.

Fully automated and computer-based grading will bring complete objectivity to the market and have a standard that is set in the process, however even in the industry there is great variability between different grading machines that currently exist. In automated grading, when a card is run through the machine, it provides an accurate readout of the condition and provides a grade. Next time when the same card is run through the machines, as long as there is no further damage or there is no change in the condition of the card during the process of removing it from the case and putting it back in, the grade will remain the same. This is not the case when a grade of the card is generated by a person. Thus, with the automated process of grading, the human element in assessing the grade or condition of the card is removed, and the value depends on purely the condition of the card from an objective point of view.

Grading of cards is based on various characteristics that pertain to the general eye appeal of the card. Characteristics of the card that are universally examined in the grading process are centering, corners, edges, and surface. Centering is the placement of the image (top to bottom and left to right) on the card relative to the card borders. Industry standards exist for percentage of off-centering variance permitted for each of the possible card grades. The corners of the card are inspected to determine the quality of the physical condition of the corner and/or if any defect of the corners is present. The edges of the card are examined, similarly to the corners, to determine the quality of the physical condition of the edges of the card, and account for any damage and/or imperfections along the edges. The surface of the card is examined to account for any damage and/or imperfections on the card, such as scratches, creases, tears, pinholes, stains, dents, attempts at recoloring, etc.

The present invention grades the condition of the card; it is important that the device is a safe environment for all cards. Essentially, the card is not to be damaged inside the device while being handled by a human or a machine. All damage to the card must be prevented, and the card should be handled minimally by both man and machine. The operator touches the card twice, once when inserting the card into the system, and once when removing it. While the card is inside the machine, it gathers data to assess the condition of the card. The device scans both sides of the card and the edges with all cameras/sensors. In addition to the detection of physical defects/damages, the device can detect the centering of the image on the card to the nearest 0.025 mm. It further evaluates any defects or damages present on the surface or anywhere on the card.

In an embodiment, the device takes about a minute to scan, compute, process, and output the card condition data. Moreover, the machine exhibits a long runtime and doesn't freeze or require reset after a few grading cycles. The device can be operated continuously for many hours, days, weeks, even years without any issues.

Since the biggest issue with card grading has to do with the subjectivity of the grading process, the device eliminates subjectivity by objectively collecting the card condition data and processing all collected data. The device produces similar data and grades for a card when tested more than once.

Cards are generally graded based on the primary attributes of Centering, Corners, Edges, and Surface. Sometimes autographs are also included in the analysis. Each attribute is generally given a grade of 1-10 and then combined to get the overall final grade of the card on a scale of 1-10. The attributes may vary in weight based on the type of card, but overall, these attributes are analyzed for the grading process.

Centering: Centering is basically the width of the border. Ideally, the border sizing should be equal on the left, right, top and bottom. Sometimes judging the centering won't be as simple as looking for equal spaced borders. The ultimate criterion is that the card should feel balanced. If a card appears lopsided, this means the centering is off. Additionally, how parallel the left/right and top/bottom inner border lines of the card are taken into consideration. This is related to the “angle” deviation of the card. A zero (0) angle deviation correlates with a perfect score. This “angle” is coupled with the spacing mentioned in this paragraph to determine centering.

Corners: A card with four sharp corners can alleviate other concerns, especially with older cards. All four corners are analyzed looking at the front of the card and then looking at the back of the card. All the corners are checked for any imperfections either on one side or on both sides.

Edges: The four edges of a card are important. Edges should be sharp, and the color should be constant. Edges are observed for imperfections such as peeling off, dings, dents, or subtle discolorations.

Surface: Surface is the condition of the card considered as a whole. Cards are observed for glossy finish, scratches on the surface, and faded autographs. If the card is made of foil stock, they are observed for imperfections or defects like small pieces of foil coming off, leaving white specks on the card. The cards are observed for creases, moisture damage, factory print lines, dirt, general whitening, tears, holes, stains, ink smearing, and stamp marks. Many times, a crease is hard to notice, as the picture on a card can hide one very well.

For simplicity and clarity of illustration, the drawing figures illustrate the general manner of construction, and descriptions and details of well-known features and techniques may be omitted to avoid unnecessarily obscuring the present disclosure. Additionally, elements in the drawing figures are not necessarily drawn to scale. For example, the dimensions of some of the elements in the figures may be exaggerated relative to other elements to help improve understanding of embodiments of the present disclosure. The same reference numerals in different figures denotes the same elements.

The terms “first”, “second”, “third”, “fourth”, and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include” and “have”, and any variations thereof, are intended to cover a non-exclusive inclusion, such that a process, method, system, article, device, or apparatus that comprises a list of elements is not necessarily limited to those elements, but may include other elements not expressly listed or inherent to such process, method, system, article, device, or apparatus.

The terms “left”, “right”, “front”, “back”, “top”, “bottom”, “over”, “under”, and the like in the description and in the claims, if any, are used for descriptive purposes and not necessarily for describing permanent relative positions. It is to be understood that the terms so used are interchangeable under appropriate circumstances such that the embodiments of the apparatus, methods, and/or articles of manufacture described herein are, for example, capable of operation in other orientations than those illustrated or otherwise described herein.

No element, act, or instruction used herein should be construed as critical or essential unless explicitly described as such. Also, as used herein, the articles “a” and “an” are intended to include items and may be used interchangeably with “one or more.” Furthermore, as used herein, the term “set” is intended to include items (e.g., related items, unrelated items, a combination of related items, and unrelated items, etc.), and may be used interchangeably with “one or more.” Where only one item is intended, the term “one” or similar language is used. Also, as used herein, the terms “has”, “have”, “having”, or the like are intended to be open-ended terms. Further, the phrase “based on” is intended to mean “based, at least in part, on” unless explicitly stated otherwise.

The terms “couple”, “coupled”, “couples”, “coupling”, and the like should be broadly understood and refer to connecting two or more elements mechanically and/or otherwise. Two or more electrical elements may be electrically coupled together but not be mechanically or otherwise coupled together. Coupling may be for any length of time, e.g., permanent or semi-permanent or only for an instant. “Electrical coupling” and the like should be broadly understood and include electrical coupling of all types. The absence of the word “removably”, “removable”, and the like near the word “coupled”, and the like does not mean that the coupling, etc. in question is or is not removable.

As defined herein, two or more elements are “integral” if they are comprised of the same piece of material. As defined herein, two or more elements are “non-integral” if each is comprised of a different piece of material.

As defined herein, “real-time” can, in some embodiments, be defined with respect to operations carried out as soon as practically possible upon occurrence of a triggering event. A triggering event can include receipt of data necessary to execute a task or to otherwise process information. Because of delays inherent in transmission and/or in computing speeds, the term “real time” encompasses operations that occur in “near” real time or somewhat delayed from a triggering event. In a number of embodiments, “real time” can mean real time less a time delay for processing (e.g., determining) and/or transmitting data. The particular time delay can vary depending on the type and/or amount of the data, the processing speeds of the hardware, the transmission capability of the communication hardware, the transmission distance, etc. However, in many embodiments, the time delay can be less than approximately one second, two seconds, five seconds, or ten seconds.

The present invention may be embodied in other specific forms without departing from its spirit or characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

As defined herein, “approximately” can, in some embodiments, mean within plus or minus ten percent of the stated value. In other embodiments, “approximately” can mean within plus or minus five percent of the stated value. In further embodiments, “approximately” can mean within plus or minus three percent of the stated value. In yet other embodiments, “approximately” can mean within plus or minus one percent of the stated value.

Unless otherwise defined herein, scientific and technical terms used in connection with the present invention shall have the meanings that are commonly understood by those of ordinary skill in the art. Further, unless otherwise required by context, singular terms shall include pluralities and plural terms shall include the singular. Generally, nomenclatures used in connection with, and techniques of, health monitoring described herein are those well-known and commonly used in the art.

The methods and techniques of the present invention are generally performed according to conventional methods well known in the art and as described in various general and more specific references that are cited and discussed throughout the present specification unless otherwise indicated. The nomenclatures used in connection with, and the procedures and techniques of embodiments herein, and other related fields described herein are those well-known and commonly used in the art.

As used herein, the term component is intended to be broadly construed as hardware, firmware, and/or a combination of hardware and software.

Implementations and all of the functional operations described in this specification may be realized in digital electronic circuitry, or in computer software, firmware, or hardware, including the structures disclosed in this specification and their structural equivalents, or in combinations of one or more of them. Implementations may be realized as one or more computer program products i.e., one or more modules of computer program instructions encoded on a computer readable medium for execution by, or to control the operation of, data processing apparatus. The computer readable medium may be a machine-readable storage device, a machine-readable storage substrate, a memory device, a composition of matter effecting a machine-readable propagated signal, or a combination of one or more of them. The term “computing system” encompasses all apparatus, devices, and machines for processing data, including by way of example a programmable processor, a computer, or multiple processors or computers. The apparatus may include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal that is generated to encode information for transmission to a suitable receiver apparatus.

The actual specialized control hardware or software code used to implement these systems and/or methods is not limiting of the implementations. Thus, the operation and behavior of the systems and/or methods were described herein without reference to specific software code-it being understood that software and hardware can be designed to implement the systems and/or methods based on the description herein.

A computer program (also known as a program, software, software application, script, or code) may be written in any appropriate form of programming language, including compiled or interpreted languages, and it may be deployed in any appropriate form, including as a standalone program or as a module, component, subroutine, or other unit suitable for use in a computing environment. A computer program does not necessarily correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one computer or on multiple computers that are located at one site or distributed across multiple sites and interconnected by a communication network.

The processes and logic flows described in this specification may be performed by one or more programmable processors executing one or more computer programs to perform functions by operating on input data and generating output. The processes and logic flows may also be performed by, and apparatus may also be implemented as, special purpose logic circuitry, for example without limitation, a Field Programmable Gate Array (FPGA), an Application Specific Integrated Circuit (ASIC), Application Specific Standard Products (ASSPs), System-On-a-Chip (SOC) systems, Complex Programmable Logic Devices (CPLDs), etc.

While this specification contains many specifics, these should not be construed as limitations on the scope of the disclosure or of what may be claimed, but rather as descriptions of features specific to particular implementations. Certain features that are described in this specification in the context of separate implementations may also be implemented in combination with a single implementation. Conversely, various features that are described in the context of a single implementation may also be implemented in multiple implementations separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems may generally be integrated together into a single software product or packaged into multiple software products.

The foregoing disclosure provides illustration and description but is not intended to be exhaustive or to limit the implementations to the precise form disclosed. Modifications and variations are possible in light of the above disclosure or may be acquired from the practice of the implementations.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, etc. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects may generally be referred to herein as a “circuit,” “module”, or “system.” Furthermore, aspects of the present invention may take the form of a computer program product embodied in one or more computer readable medium(s) having computer readable program code/instructions embodied thereon.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowcharts and block diagrams in the Figures illustrate the architecture, functionality, and operation of possible implementations of systems, methods, and computer program products according to various embodiments of the present invention. In this regard, each block in the flowcharts may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the flowchart illustrations, and combinations of blocks in the flowchart illustrations, can be implemented by special purpose hardware-based systems that perform the specified functions or acts or carry out combinations of special purpose hardware and computer instructions.

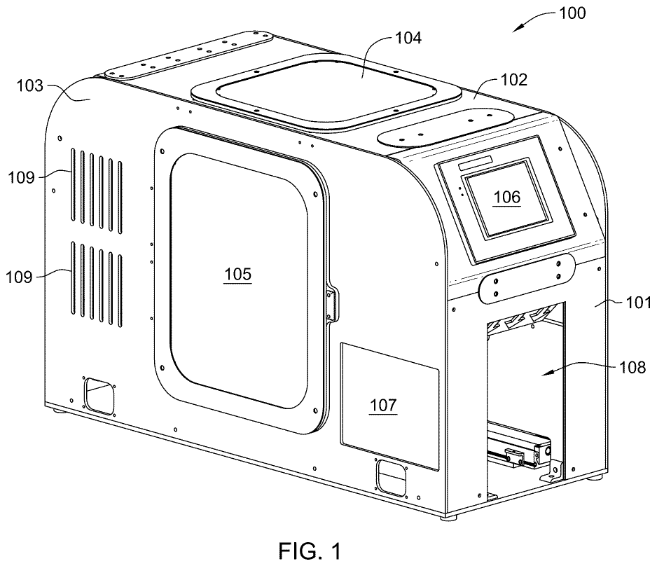

FIG. 1 depicts an isometric view of a grading machine 100, according to an embodiment of the present invention. The grading machine has a case which contains the internal components that perform the grading of the cards and/or collectibles. In the present view, the grading machine 100 has a front panel 101, a top panel 102, a side panel 103, and side panel 111. The front panel 101 has an opening 108 which is where the card or collectible is inserted into to be graded. This opening 108 is based on the size of the object of which the grading machine 100 is able to grade/scan. The top panel 102 has a window 104 and side panel 103 has a door 105 to view the internals. The door 105 is hinged and able to be opened or closed and is able to latch close. Screens 106 and 107 allow for control and operations of the grading machine 100.

In the present embodiment these screens 106 and 107 are touch screens which allow for the control and operation of the grading machine 100, as well as viewing results of the grading process. In alternative embodiments, the screens 106 and 107 may have buttons or controls that are mechanical to assist in the operation of the grading machine 100. Side panel 103 has slats 109 to allow for cooling of the internal electrical and mechanical components. The grading machine 100 has adjustable feet 110 to allow for the setting up of the grading machine 100 so that it is level. The exterior panels are attached to one another through various fasteners of connection means.

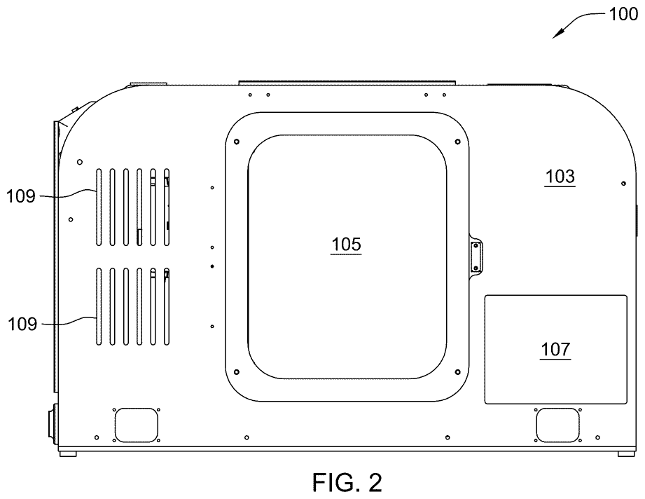

FIG. 2 depicts a side view of the grading machine 100, according to an embodiment of the present invention. The door 105 is shown with hinges 112 and latch 113. In the depicted embodiment, the profile of the grading machine 100 has a curved top edge.

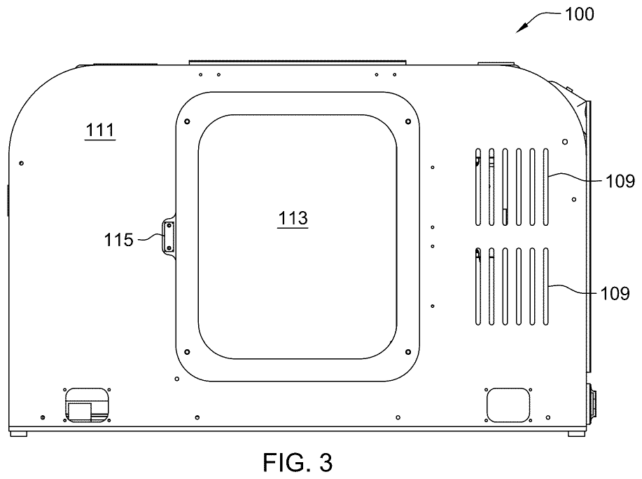

FIG. 3 depicts a side view of the grading machine 100, according to an embodiment of the present invention. The side 111 has a door 113 with hinges 114 and latch 115 to allow access to the interior of the grading machine 100. Slats 109 are incorporated into the side 111 to allow for cooling of the internal components. In the depicted embodiment, the profile of the grading machine 100 has a curved top edge.

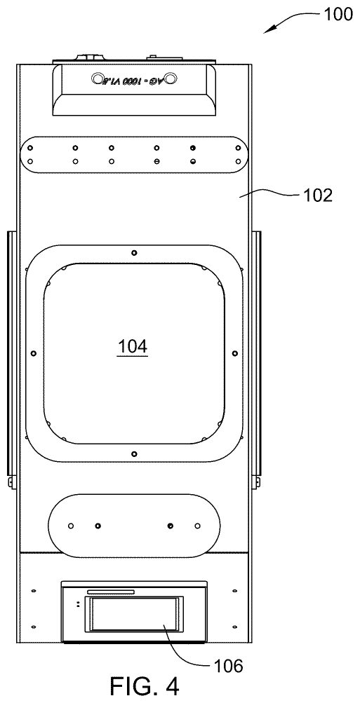

FIG. 4 depicts a top view of the grading machine 100, according to an embodiment of the present invention.

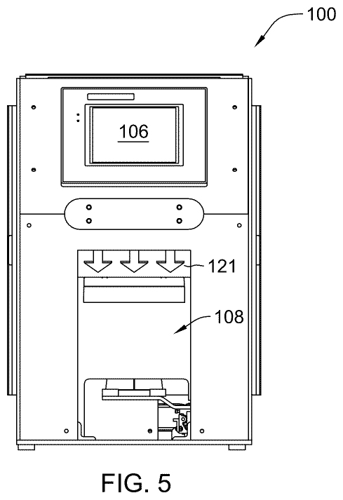

FIG. 5 depicts a front view of the grading machine 100, according to an embodiment of the present invention. Opening 108 is shown having panel 121 showing the maximum height of the object which can be placed for grading. The conveyor system is shown for which the object is placed on to allow for the object to be transferred into the grading machine 100 for the grading process.

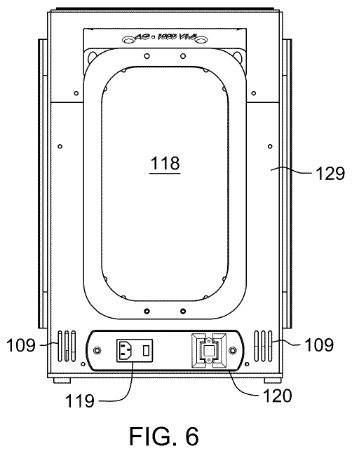

FIG. 6 depicts a back view of the grading machine 100, according to an embodiment of the present invention. Panel 129. Window 118 allows a view of the interior of the grading machine 100. Connectors 119 and 120 are shown on panel 117. In various embodiments connectors 119 and 120 may be replaced with various other connectors or panel 117 may have additional connectors. In the present embodiment connector 120 is for power and connector 119 is for internet access (e.g. ethernet connector).

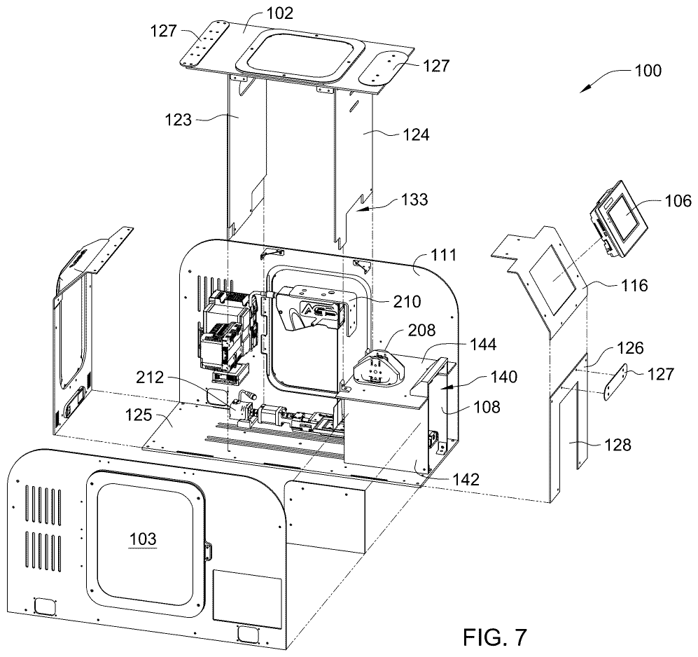

FIG. 7 depicts an exploded view of the grading machine 100, according to an embodiment of the present invention. Various parts of the grading machine are shown disassembled. Top panel 102 is shown with dividers 123 and 124 attached to the top panel 102. These dividers are used to separate the grading chamber from the rear portion of the grading machine where the electrical components are stored. As well as to separate the grading chamber from outside. This is done so that the grading components are not easily accessible and thus cannot be easily damaged and to limit the amount of interference from outside while the grading process is taking place. Divider 124 has cutout 133 to allow the lease amount of opening available for the object to pass from the receiving chamber to the grading chamber.

The receiving chamber is formed by panels 140, 142, and 144. These panels are contained within the main body and include panel 121 that provides for the area which the platform 200 rests to allow the user or device to place or insert the object onto the platform 200. These panels 140, 142, and 144 interface with divider 124. The receiving chamber is substantially separate from the grading chamber to keep the grading system free of interference and contaminants.

Front panel 101 has panels 116 and panel 126 attached to the front panel 101. This panel assembly creates the opening 108 entry for the grading machine 100. Panel 126 has aperture 128 to allow for the scanning components to be positioned through, as described below.

The panels are secured together using fasteners and brackets. In additional embodiments, the panels may be welded or secured together by various other means known to one skilled in the art. In some embodiments, brackets 127 are used to secure various panels together. In various other embodiments, the brackets 127 and fasteners are used to secure the panels together. Grading system 210 is attached to bracket 129 and secured to divider 124. The various computing devices and hardware is secured to divider 125. Base 125 is shown which provides the platform in which the grading components are secured.

The housing of the grading machine 100, such as the panels, dividers, and base are made of metal. In various embodiments, the panels and base may be made from other materials, provided the materials provide the structural support required. The windows or doors are made from glass or a clear plastic material such as acrylic or polycarbonate.

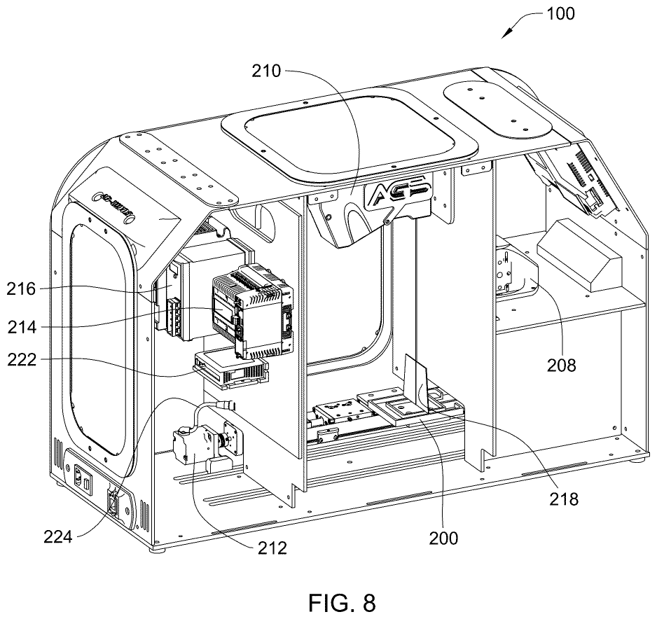

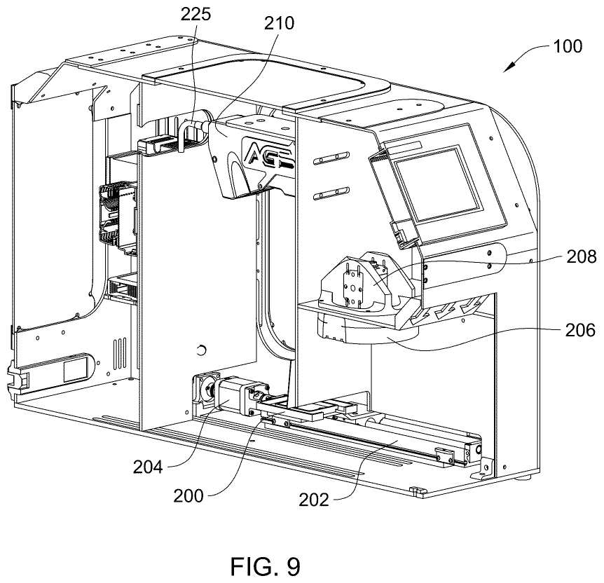

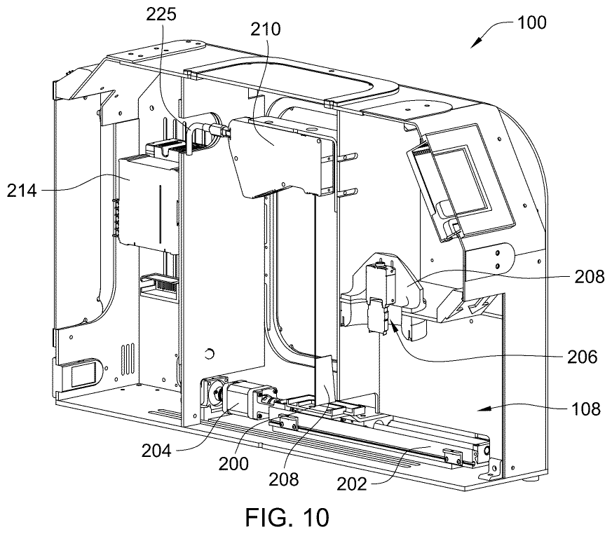

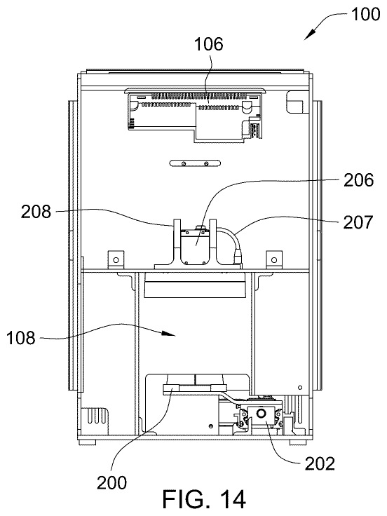

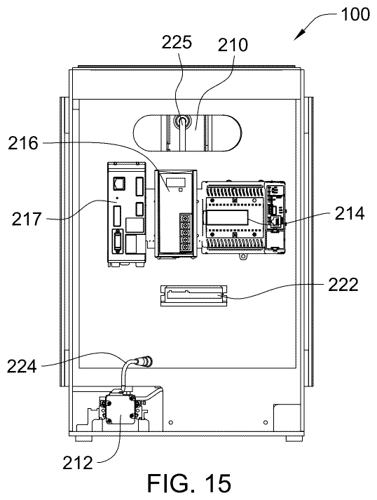

FIGS. 8-15 depict various section views of the grading machine 100, according to an embodiment of the present invention. Platform 200 is shown where the card or object is placed for grading. The platform 200 may have various designed and contours for various types of objects. Specifically for cards, the platform 200 has a contour that fits the card within the platform 200 to reduce movement or shifting during the grading process. The platform 200 is attached to rail(s) 202 which all for the translation/movement of the platform 200 from the receiving chamber to the grading chamber. The platform 200 is controlled by a motor/actuator 204 which is attached to the rail(s) 202 and/or the platform 200. Shown in the rear compartment are the computing devices 214, 216, 217, and 222 which control the movement of the internal components, the operation of the sensors, cameras, and lights, and processing of the collected data. The computing devices allow for the grading machine 100, to be a completely mobile system. The rotary encoder 212 and attached encoder cable 224 provide the conversion of the position and/or motion of the shaft to a digital output. This data is used for the analysis of the object in conjunction with the lasers, sensors, or cameras. The guide 218 provides the field view for the lasers, sensors, or cameras to provide a guide to assist in confirming that the object entirety can be analyzed by the lasers, sensors, or cameras Grading system 210 provides for the sensors, cameras, and lights which perform the analysis on the object as it passes through the grading chamber. Within the grading chamber, the grading system 210, in the depicted embodiment is a single unit which contains the sensors, cameras, and lights given that the object is typically a card which is relatively flat and is analyzed from a single perspective (e.g. top down). In additional embodiments, multiple sensors, cameras, and/or lighting devices are positioned throughout the grading chamber to allow for the necessary coverage of the object for grading. The grading system 210 is connected to the computing devices 214, 216, 217, and/or 222 via cable 225.

In addition to the grading system 210, the grading machine 100 has a vision system 206 which is positioned in the front portion (opening 108) of the grading machine 100. The vision system 206 is held in place with bracket 208. The vision system 206 provides for a first analysis and data collection of the object prior to the grading system 210 being activated to perform the analysis of the object. The vision system 206 determines alignment, object features, if the object is 2D or 3D, and sets a zero positioning value. This provides the necessary prerequisite date for the grading system 210 to base the analysis off of. Cable 207 connected the vision system 206 to computing devices 214, 216, 217, and/or 222.

The vision system 206, the grading system 210, and the track system 202 are all connected to the computing devices 214, 216, 217, and/or 222. This allows each system to be operated in unison with the other systems so that vision system 206 is able to analyze the object in the first chamber, the track system then translated the platform 200 into the second chamber for the grading system 210 to perform the second analysis on the object, while the computing devices 214, 216, 217, and/or 222 are able to receive the data, process the data, and send commands to the various system components.

In an example of the operation of the grading machine 100, an object is placed on the platform 200, it passes from the receiving chamber to the grading chamber, wherein upon the entry into the grading chamber grading system 210 scans the object from a first end to a second end as it moves from the entry of the grading chamber to the rear of the grading chamber. The object then passes back through the grading system 210 scan a second time as it passes from the rear of the grading chamber to the receiving chamber. The object may pass through the grading chamber multiple times till the grading system 210 has a complete set of results based on the object type.

In some embodiments, the platform 200 is lined with non-adhesive, non-staining, and dust resistant materials ranging from metals to fine cloth. The platform 200 may contains holes for comfortable handling of card or collectible onto the platform.

In some embodiments, a filtration system may be integrated into the grading machine 100 to make sure the internal compartments are clean of dust a debris which could affect the images and scans.

In some embodiments, the platform 200 is able to rotate along a first axis, so that the object after it passes through the sensor in a first direction, is able to be rotated without any human interference and allow for additional scans of the object from multiple angles. In some embodiments where the object is specifically a card, the platform is able to flip the card over to allow for grading of the top and bottom surfaces. The flipping or rotating of the card or object respectively is done based on the scans which are requested by the user and the grading machine's initial analysis of the object that is scanned to determine a complete scan has been done. In some embodiments, the platform 200 is able to tilt, so that the object is the correct angle relative to the grading system 210.

In another embodiment, the grading machine 100 is able to clean the object which is placed on the platform 200. Through compressed air, and ports which are positioned at a distance and set at a pressure so as to ensure object does not damage and dirt is cleaned.

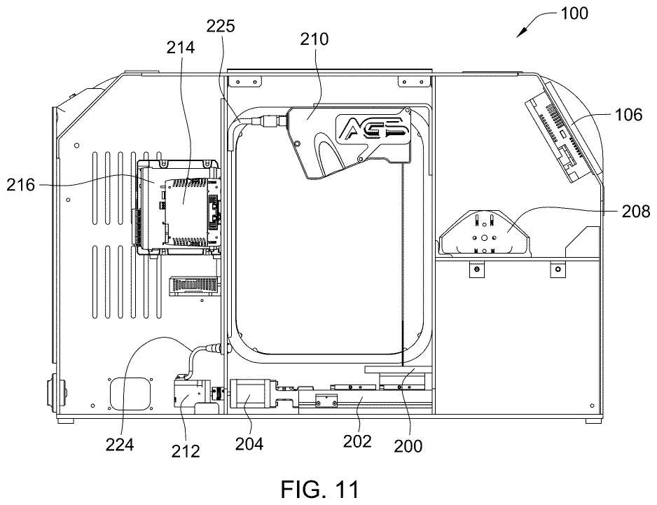

FIG. 11 depicts a block diagram of the grading machine 100, in accordance with one embodiment of the present invention.

The grading system 210 provides the sensors, cameras, and lighting which are used to physically analyze the object to collect relevant data based on the object type and the desired analysis to be performed.

The object movement system 302 provides for the movement of the object from the receiving area into and through the grading system 210. Based on the inputs received from the screens, or an initial analysis of the object, the object movement system 302 and the grading system 210 are adjusted to properly analyze the object. This can be shown in the speed of the object movement system 302 operates or the types of sensors or cameras which the grading system 210 uses to analyze the object.

Network 310 may be a local area network (LAN), a wide area network (WAN) such as the Internet, any combination thereof, or any combination of connections and protocols that can support communications between the computing device 304 and a mobile device 312 in accordance with embodiments of the invention. Network 310 may include wired, wireless, or fiber optic connections.

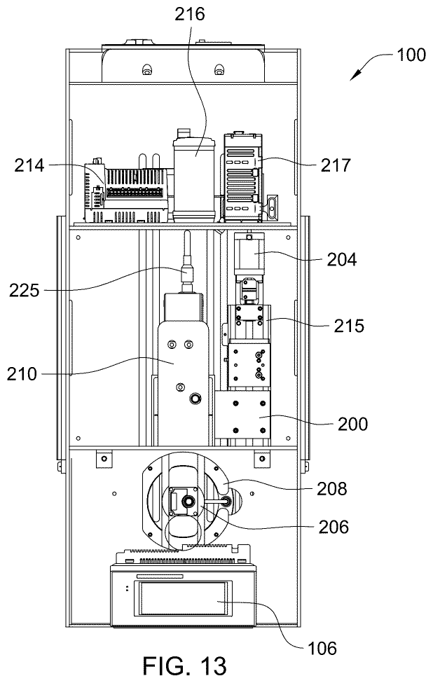

Computing device 304 may be a management server, a web server, or any other electronic device or computing system capable of processing program instructions and receiving and sending data. In other embodiments, computing device 304 may be a laptop computer, tablet computer, netbook computer, personal computer (PC), a desktop computer, or any programmable electronic device capable of communicating with the grading system 210, screens 106 and 107, and object movement system 302 through direct connection. In other embodiments, computing device 304 may be a server computing system utilizing multiple computers as a server system, such as in a cloud computing environment. In one embodiment, computing device 304 represents a computing system utilizing clustered computers and components to act as a single pool of seamless resources. computing device 304 may include components, as depicted and described in further detail with respect to FIG. 13.

Grading Module 306 operates to perform the operational steps of the grading system 210 and perform the grading analysis of the card. In the depicted embodiment, the grading module 306 is on the computing device 304 and utilizes network 310 to access the mobile device 103. In other embodiments, grading module 306 may be located on another server or computing device, provided grading module 306 has access to the database 308,, grading system 210, and object movement system 302.

Database 308 may be a repository that may be written to and/or read by grading module 110. Information gathered from the grading module 306, grading system 210, and object movement system 302 may be stored to database 308. In one embodiment, database 308 is a database management system (DBMS) used to allow the definition, creation, querying, update, and administration of a database(s). In the depicted embodiment, database 308 resides on computing device 304. In other embodiments, database 308 resides on another server, or another computing device, provided that database 308 is accessible to grading module 306, grading system 210, and object movement system 302.

Mobile device 312 may be a management server, a web server, or any other electronic device or computing system capable of processing program instructions and receiving and sending data. In some embodiments, mobile device 312 may be a laptop computer, tablet computer, netbook computer, personal computer (PC), a desktop computer, or any programmable electronic device capable of communicating with computing device 304 via network 310. In other embodiments, mobile device 312 may represent a server computing system utilizing multiple computers as a server system, such as in a cloud computing environment. In another embodiment, mobile device 312 represents a computing system utilizing clustered computers and components to act as a single pool of seamless resources.

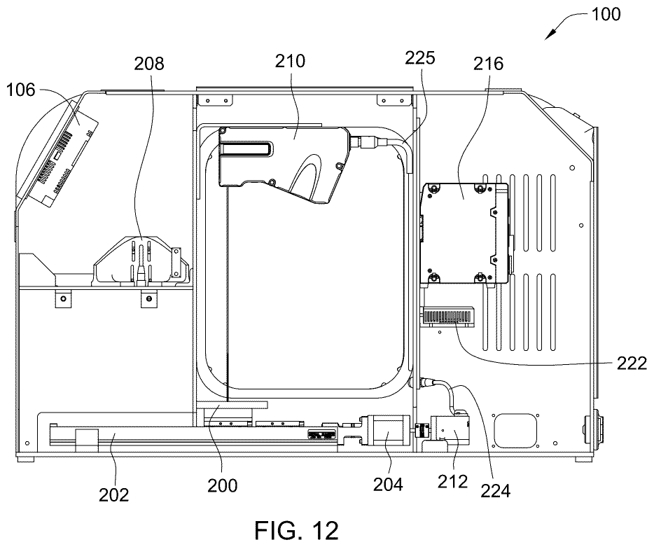

FIG. 12 depicted another embodiment of a block diagram of a computing environment 100B in accordance with one embodiment of the present invention. In the present embodiment, the computing environment 100B is comprised of a network 102, server 105, a mobile device 103, a grading machine 105, a labeling machine 10, an encapsulating machine 280, and a camera/scanner 109.

The grading machine 105, the labeling machine 10, and the encapsulating machine 280 are all separate machines that communicate with the database 114 and the grading module 104 via network 102. This embodiment requires a person or external piece of machinery to transfer the card from one machine to the next. In some embodiments, a machine is positioned relative to all three machines to transfer the card from one to the next. The grading machine 105, the labeling machine 10, and the encapsulating machine 280 all have the necessary computing devices and components to communicate with the server 105 via network 102. The camera/scanner 109 is used to capture an image or scan of the card once it is encapsulated.

Server 105 may be a management server, a web server, or any other electronic device or computing system capable of processing program instructions and receiving and sending data. In other embodiments server 105 may be a laptop computer, tablet computer, netbook computer, personal computer (PC), a desktop computer, or any programmable electronic device capable of communicating via network 102 with the mobile device 103, the grading machine 105, the labeling machine 10, and the encapsulating machine 280. In one embodiment, server 105 may be a server computing system utilizing multiple computers as a server system, such as in a cloud computing environment. In one embodiment, server 105 represents a computing system utilizing clustered computers and components to act as a single pool of seamless resources. In the depicted embodiment database 114 and grading module 104 are located on server 105. Server 105 may include components, as depicted and described in further detail with respect to FIG. 13.

FIG. 13, a schematic of an example of a cloud computing node is shown. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionalities set forth hereinabove.

In cloud computing node 10 there is a computer device/server 12, which is operational with numerous other general purpose or special purpose computing system environments or configurations. Examples of well-known computing systems, environments, and/or configurations that may be suitable for use with computer device/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

computer device/server 12 may be described in the general context of computer system executable instructions, such as program modules, being executed by a computer system. Generally, program modules may include routines, programs, objects, components, logic, data structures, and so on that perform particular tasks or implement particular abstract data types. computer device/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 13, computer device/server 12 in cloud computing node 10 is shown in the form of a general-purpose computing device. The components of computer device/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

computer device/server 12 typically includes a variety of computer system readable media. Such media may be any available media that is accessible by computer device/server 12, and it includes both volatile and non-volatile media, removable and non-removable media.

System memory 28 can include computer system readable media in the form of volatile memory, such as random access memory (RAM) 30 and/or cache memory 32. computer device/server 12 may further include other removable/non-removable, volatile/non-volatile computer system storage media. By way of example only, storage system 34 can be provided for reading from and writing to a nonremovable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

computer device/server 12 may also communicate with one or more external devices 14 such as a keyboard, a pointing device, a display 24, etc.; one or more devices that enable a user to interact with computer device/server 12; and/or any devices (e.g., network card, modem, etc.) that enable computer device/server 12 to communicate with one or more other computing devices. Such communication can occur via Input/Output (I/O) interfaces 22. Still yet, computer device/server 12 can communicate with one or more networks such as a local area network (LAN), a general wide area network (WAN), and/or a public network (e.g., the Internet) via network adapter 20. As depicted, network adapter 20 communicates with the other components of computer device/server 12 via bus 18. It should be understood that although not shown, other hardware and/or software components could be used in conjunction with computer device/server 12. Examples, include, but are not limited to: microcode, device drivers, redundant processing units, external disk drive arrays, RAID systems, tape drives, and data archival storage systems, etc.

While this invention has been described in conjunction with the specific embodiments outlined above, it is evident that many alternatives, modifications and variations will be apparent to those skilled in the art. Accordingly, the preferred embodiments of the invention, as set forth above, are intended to be illustrative, not limiting. Various changes may be made without departing from the spirit and scope of this invention.

While this invention has been described in conjunction with the specific embodiments outlined above, it is evident that many alternatives, modifications and variations will be apparent to those skilled in the art. Accordingly, the preferred embodiments of the invention, as set forth above, are intended to be illustrative, not limiting. Various changes may be made without departing from the spirit and scope of this invention.

It will be further understood that various changes in the details, materials, and arrangements of the parts which have been described and illustrated in order to explain the nature of this invention may be made by those skilled in the art without departing from the scope of the invention as expressed in the following claims.

Present invention: should not be taken as an absolute indication that the subject matter described by the term “present invention” is covered by either the claims as they are filed, or by the claims that may eventually issue after patent prosecution; while the term “present invention” is used to help the reader to get a general feel for which disclosures herein that are believed as maybe being new, this understanding, as indicated by use of the term “present invention,” is tentative and provisional and subject to change over the course of patent prosecution as relevant information is developed and as the claims are potentially amended.

The foregoing descriptions of various embodiments have been presented only for purposes of illustration and description. They are not intended to be exhaustive or to limit the present invention to the forms disclosed. Accordingly, many modifications and variations of the present invention are possible in light of the above teachings, which will be apparent to practitioners skilled in the art. Additionally, the above disclosure is not intended to limit the present invention. In the specification and claims the term “comprising” shall be understood to have a broad meaning similar to the term “including” and will be understood to imply the inclusion of a stated integer or step or group of integers or steps but not the exclusion of any other integer or step or group of integers or steps. This definition also applies to variations on the term “comprising” such as “comprise” and “comprises”.

Although various representative embodiments of this invention have been described above with a certain degree of particularity, those skilled in the art could make numerous alterations to the disclosed embodiments without departing from the spirit or scope of the inventive subject matter set forth in the specification and claims. Joinder references (e.g., attached, adhered, joined) are to be construed broadly and may include intermediate members between a connection of elements and relative movement between elements. As such, joinder references do not necessarily infer that two elements are directly connected and in fixed relation to each other. Moreover, network connection references are to be construed broadly and may include intermediate members or devices between network connections of elements. As such, network connection references do not necessarily infer that two elements are in direct communication with each other. In some instances, in methodologies directly or indirectly set forth herein, various steps and operations are described in one possible order of operation, but those skilled in the art will recognize that steps and operations may be rearranged, replaced, or eliminated without necessarily departing from the spirit and scope of the present invention. It is intended that all matter contained in the above description or shown in the accompanying drawings shall be interpreted as illustrative only and not limiting. Changes in detail or structure may be made without departing from the spirit of the invention as defined in the appended claims.

Although the present invention has been described with reference to the embodiments outlined above, various alternatives, modifications, variations, improvements and/or substantial equivalents, whether known or that are or may be presently foreseen, may become apparent to those having at least ordinary skill in the art. Listing the steps of a method in a certain order does not constitute any limitation on the order of the steps of the method. Accordingly, the embodiments of the invention set forth above are intended to be illustrative, not limiting. Persons skilled in the art will recognize that changes may be made in form and detail without departing from the spirit and scope of the invention. Therefore, the invention is intended to embrace all known or earlier developed alternatives, modifications, variations, improvements and/or substantial equivalents.

What is claimed is:

1. A computerized system for grading an object, comprising:
an enclosure;
a platform designed to receive an object;
a track system integrated into the enclosure and wherein the platform is attached to the track system;
a scanning system integrated into the enclosure relative to the track system, wherein the scanning system is configured to capture at least one image of the object; and
a computer system connected to the scanning system and the track system, comprising at least one processor.

2. The computerized system for grading a collectible of claim 1, wherein the track system, further comprises, a motorization system integrated into the track system for linear movement of the platform.

3. The computerized system for grading a collectible of claim 1,, wherein the track system, further comprises, a motorization system integrated into the track system for multi-directional movement of the platform.

4. The computerized system for grading a collectible of claim 1, wherein the enclosure has a first chamber and a second chamber, wherein the platform is accessible in the first chamber.

5. The computerized system for grading a collectible of claim 1, wherein the scanning system, further comprises, at least one camera, at least one scanner.

6. The computerized system for grading a collectible of claim 1, further comprising, at least one display module integrated into the enclosure and in communication with the computer system.

7. The computerized system for grading a collectible of claim 1, wherein the computer system receives at least one signal from the scanning system, and wherein a grading report is generated.

8. The computerized system for grading a collectible of claim 1, further comprising a vision system integrated into the enclosure and electrically connected to the computer system.

9. The computerized system for grading a collectible of claim 8, wherein the vision system is within the first chamber.

10. The computerized system for grading a collectible of claim 8, further comprising a mount, wherein the vision system is secured within the mount.

11. A computerized system for grading an object, comprising:
an enclosure;
a rotatable platform designed to receive an object;
a track system integrated into the enclosure and wherein the platform is attached to the track system;
a vision system integrated into the enclosure relative to the track system;
a scanning system integrated into the enclosure relative to the track system and the vision system, wherein the scanning system is configured to capture at least one image of the object; and
a computer system connected to the scanning system and the track system, comprising at least one processor.

12. The computerized system for grading an object of claim 11, wherein the vision system and the scanning system are separated by a divider in the enclosure.

13. The computerized system for grading an object of claim 11, further comprising at least one interactive screen connected to the computer system.

14. The computerized system for grading an object of claim 11, wherein the vision system and the scanning system communicate with the computer system.

15. A computerized system for grading an object, comprising:
an enclosure;
a platform designed to receive an object;
a track system integrated into the enclosure and wherein the platform is attached to the track system;
a vision system integrated into the enclosure relative to the track system;
a scanning system integrated into the enclosure relative to the track system, wherein the scanning system is configured to capture at least one image of the object;
a computer system connected to the scanning system and the track system, comprising at least one processor; and
at least one interactive screen integrated into the enclosure electrically connected to the computer system.

16. The computerized system for grading an object of claim 11, wherein the vision system and the scanning system are separated by a divider in the enclosure.

17. The computerized system for grading an object of claim 11, wherein the enclosure has a plurality of access ports.

18. The computerized system for grading an object of claim 11, wherein a first chamber and a second chamber are formed by a divider within the enclosure separating the vision system from the scanning system.

19. The computerized system for grading an object of claim 11, wherein the vision system performs a first analysis of the object and the scanning system performs a second analysis of the object.

20. The computerized system for grading an object of claim 11, wherein the scanning system, vision system, and track system all operate in unison.
